(19) United States
(12) Patent Application Publication
(10) Pub. No.: US 2021/0398158 A1
(43) Pub. Date: Dec. 23, 2021

(54) MODIFYING A POLICY OF AN INPUT/OUTPUT DEVICE IN RESPONSE TO EXTERNAL PROMOTIONAL EVENTS

(71) Applicant: Intuition Robotics, Ltd., Ramat-Gan (IL)

(72) Inventors: Shay ZWEIG, Harel (IL); Alex KEAGEL, Tel Aviv (IL); Itai MENDELSOHN, Ramat-Gan (IL); Roy AMIR, Tel Aviv (IL); Dor SKULER, Oranit (IL); Eldar RON, Tel Aviv (IL)

(73) Assignee: Intuition Robotics, Ltd., Ramat-Gan (IL)

(21) Appl. No.: 17/351,889

(22) Filed: Jun. 18, 2021

Related U.S. Application Data
(60) Provisional application No. 63/040,812, filed on Jun. 18, 2020.

(51) Int. Cl. G06Q 30/02

(52) U.S. Cl. CPC G06Q 30/0211; G06Q 30/0255

(57) ABSTRACT

A method and system for generating a modified input/output (I/O) device policy in response to external promotional events. The method includes generating a modified policy based on a request to promote at least one service, wherein the modified policy is generated based on at least one service currently defined in an initial policy of the I/O device and similar to the at least one service to be prompted; determining a current state of a user of the I/O device based on a collected dataset related to a user of the I/O device; and executing, based on the current state, at least one plan defined in the modified policy, wherein executing the at least one plan further includes causing the I/O device to activate at least one service to be prompted.

### CROSS-REFERENCE TO RELATED APPLICATIONS

This application claims the benefit of U.S. Provisional Application No. 63/040,812 filed on Jun. 18, 2020, the contents of which are hereby incorporated by reference.

### TECHNICAL FIELD

The disclosure generally relates to digital assistants configured to cause outputs via input/output (I/O) devices and, more specifically, to a system and method for modifying policies operating such devices based on external promotional events.

### BACKGROUND

As manufacturers improve the functionality of devices such as vehicles, computers, mobile phones, appliances, and the like, through the addition of digital features, manufacturers and end-users may desire enhanced device functionalities. The manufacturers, as well as the relevant end-users, may desire digital features which improve user experiences, interactions, and features which provide for greater connectivity. Certain manufacturers may include device-specific features, such as setup wizards and virtual assistants, to improve device utility and functionality. Further, certain software packages may be added to devices, either at the point of manufacture, or by a user after purchase, to improve device functionality. Such software packages may provide functionalities including, as examples, a computer system's voice control, facial recognition, biometric authentication, and the like.

While the features and functionalities described hereinabove provide for certain enhancements to a user's experience when interacting with a device, the same features and functionalities, as may be added to a device by a user or manufacturer, fail to include certain aspects which may allow for a further-enhanced user experience. First, certain currently-implemented digital assistants and other user experience features may fail to provide for adaptive adjustment of the operation of the assistant or feature. For example, a digital assistant configured to play music may be programmed to use a specific type of music streaming services, thereby limiting the user experience. In addition, certain currently-implemented digital assistants and other user experience features may fail to provide for adjustment of assistant or feature operation based on external events, such as promotional events. This further limits the functionality of the digital assistant as new services of features cannot be introduced.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating a modified input/output (I/O) device policy in response to external promotional events. The method comprises generating a modified policy based on a request to promote at least one service, wherein the modified policy is generated based on at least one service currently defined in an initial policy of the I/O device, and similar to the at least one service to be prompted; determining a current state of a user of the I/O device based on a collected dataset related to a user of the I/O device; and executing, based on the current state, at least one plan defined in the modified policy, wherein executing the at least one plan further includes causing the I/O device to activate at least one service to be prompted.

In addition, certain embodiments disclosed herein include a system for generating a modified input/output (I/O) device policy in response to external promotional events, comprising: a processing circuitry; and a memory, the memory containing instructions that, when executed by the processing circuitry, configure the system to: generate a modified policy based on a request to promote at least one service, wherein the modified policy is generated based on at least one service currently defined in an initial policy of the I/O device and similar to the at least one service to be prompted; determine a current state of a user of the I/O device based on a collected dataset related to a user of the I/O device; and execute, based on the current state, at least one plan defined in the modified policy, wherein executing the at least one plan further includes causing the I/O device to activate at least one service to be prompted.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram depicting a network diagram utilized to describe the various embodiments of modifying policies of an input/output device policy based on external promotional events.

FIG. 2 is a block diagram of a controller, according to an embodiment.

FIG. 3 is a flowchart illustrating a method for modifying policies of an input/output device policy in response to promotional events.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

The embodiments disclosed herein relate to the analysis of sensor data, as may relate to a user, the conditions of a user's environment, external events, and the like, as well as the application of such analyzed data to the generation, customization, and execution of various digital assistant programs, routines, services, and the like. The disclosed embodiments provide for reduced processing time and, thus, improved computational efficiency in the modification and execution of digital assistant routines; in particular, where the modification and execution of such routines include analysis of one or more attributes or data features relating to external events, such as promotional events.

By collecting and analyzing data related to user and external events received from an authorized electronic system, an initial policy defined for the I/O device operating the digital assistant is modified. The initial policy defines plans or actions to be executed by the digital assistant for a given current state of a user. A modified policy, which suits the preferences and the needs of a user while factoring the external promotional events, is generated. The modified policy is used for controlling the execution of plans, in order to adjust the plans to a user without negatively effecting the user experience when the external events are factored. The plans executed by the digital assistant include causing outputs via one or more input/output (I/O) devices.

The embodiments disclosed herein provide specific advantages in the solution of digital assistant customization problems. As multiple vendors trying to push services and products through promotional events, such events may be cumbersome or challenging for a user to accept or reject. While users may be able to manually react to such external promotional events, such a manual process is time-consuming, requires extensive communication between a user and the digital assistant, and is, ultimately a subjective process. The embodiments disclosed herein provide for objective modification of a policy executed by the digital assistant to address external promotional events which suit the preferences of a user. Moreover, historical data related to a user's preferences with respect to outputs by I/O device may be utilized to generate a modified policy for a user with respect to the I/O device.

Additionally, in accordance with various disclosed embodiments, a modified policy is generated based on an initial policy, and in particular definition included in the initial policy as whether is likely to accept or adapt to new services. This limits the number of modifications to the initial policy and improves the accuracy of the modified policy by using the most up-to-date policies of an individual user when the modified policy is about to be used to execute one or more plans. This accuracy, in turn, improves efficiency of the I/O device(s) being controlled, by avoiding unsuitable outputs which would, in turn, prompt a user to manually reconfigure the I/O device.

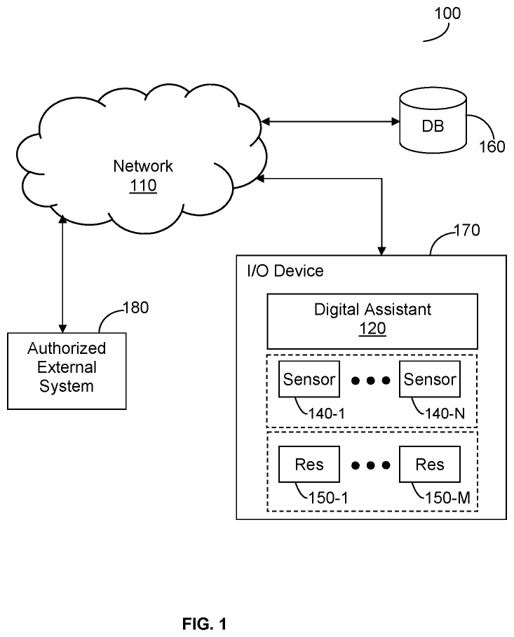

FIG. 1 is an example network diagram 100 utilized to describe the various disclosed embodiments. The network diagram 100 includes an input/output (I/O) device 170 operating a digital assistant 120 and an authorized external system 180 connected to the I/O device 170 over network 110. In some embodiments, the digital assistant 120 is further connected to a network to allow some processing of a remote server (e.g., a cloud server). The network 110 may provide for communication between the elements shown in the network diagram 100. The network 110 may be, but is not limited to, a local area network (LAN), a wide area network (WAN), a metro area network (MAN), the Internet, a wireless, cellular, or wired network, and the like, and any combination thereof.

In an embodiment, the digital assistant 120 may be connected to, or implemented on, the I/O device 170. The I/O device 170 may be, for example and without limitation, a robot, a social robot, a service robot, a smart TV, a smartphone, a wearable device, a vehicle, a computer, a smart appliance, and the like.

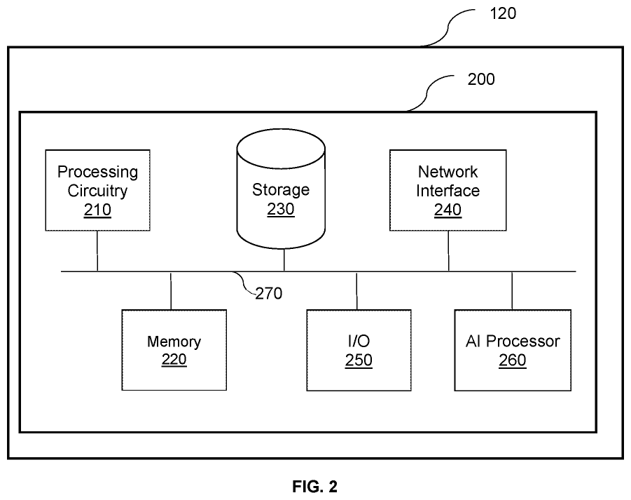

The digital assistant 120 may be realized in software, firmware, hardware, combination thereof. An example block diagram of the digital assistant 120 is provided in FIG. 2. The digital assistant 120 is configured to process sensor data collected by one or more sensors, 140-1 to 140-N, where N is an integer equal to or greater than 1 (hereinafter referred to as “sensor” 140 or “sensors” 140 for simplicity) and one or more resources 150-1 to 150-M, where M is an integer equal to or greater than 1 (hereinafter referred to as “resource” 150 or “resources” 150 for simplicity). The resources 150 may include, for example, electro-mechanical elements, display units, speakers, and the like. In an embodiment, the resources 150 may include sensors 140 as well. The sensors 140 and the resources 150 are included in the I/O device 170.

The sensors 140 may include input devices, such as various sensors, detectors, microphones, touch sensors, movement detectors, cameras, and the like. Any of the sensors 140 may be, but are not necessarily, communicatively, or otherwise connected to the digital assistant 120 (such connection is not illustrated in FIG. 1 for the sake of simplicity and without limitation on the disclosed embodiments). The sensors 140 may be configured to sense signals received from a user interacting with the I/O device 170 or the digital assistant 120, signals received from the environment surrounding the user, and the like. In an embodiment, the sensors 140 may be implemented as virtual sensors that receive inputs from online services, e.g., the weather forecast, a user's calendar, and the like.

In an embodiment, the network diagram 100 further includes a database (DB) 160. The database 160 may be stored within the I/O device 170 (e.g., within a storage device not shown), or may be separate from the I/O device 170 and connected thereto via the network 110. The database 160 may be utilized for storing, for example, historical data about one or more users, users' preferences and related policies, and the like, as well as any combination thereof.

The I/O device 170 is configured to generate, transmit, receive, or the like, as well as any combination thereof, requests (including signals and/or messages) from the external system 180. A request may include a request to change the policy employed by the I/O device 170 in response to promotional event(s). The authorized external system 180 may be, for example and without limitation, a personal computer, a server, a smartphone, a laptop, or the like. The external system 180 may be utilized for sending inputs, data, electronic messages, and the like to the I/O device 170, as further discussed hereinbelow. The external system 180 is a system separate from the I/O device 170 and may communicate with a plurality of different I/O devices 170 (not shown).

According to some examples, the digital assistant 120 is configured to modify an initial policy of the I/O device 170. A request to modify a policy of the electronic social agent is received from the authorized external system 180. The policy is modified based on the request generated in response to one or more promotional events requested by a vendor (or advertiser) of a service or product. Such a service or product is supported by the I/O device 170 (e.g., a music streaming service). Data about the user is collected, through the one or more sensors 140, and analyzed to determine a current state of the user. Then, a plan is executed by the digital assistant 120 using the modified policy and based on the determined current state of a user. The operation of the digital assistant 120 is further discussed below.

FIG. 2 is an example block diagram of a controller 200 acting as a hardware layer of a digital assistant 120, according to an embodiment. The controller 200 includes a processing circuitry 210 that is configured to receive data, analyze data, generate outputs, and the like, as further described hereinbelow. The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The controller 200 further includes a memory 220. The memory 220 may contain therein instructions that, when executed by the processing circuitry 210, cause the controller 200 to execute actions as further described hereinbelow. The memory 220 may further store therein information, e.g., data associated with one or more users, historical data about one or more users, users' preferences and related policies, and the like.

The storage 230 may be magnetic storage, optical storage, and the like, and may be realized, for example, as a flash memory or other memory technology, or any other medium which can be used to store the desired information.

In an embodiment, the controller 200 includes a network interface 240 that is configured to connect to a network, e.g., the network 110 of FIG. 1. The network interface 240 may include, but is not limited to, a wired interface (e.g., an Ethernet port) or a wireless port (e.g., an 802.11 compliant Wi-Fi card), configured to connect to a network (not shown).

The controller 200 further includes an input/output (I/O) interface 250 configured to control the resources 150 (shown in FIG. 1) which are connected to the digital assistant 120. In an embodiment, the I/O interface 250 is configured to receive one or more signals captured by the sensors 140 (see FIG. 1) of the digital assistant 120 and to send such signals to the processing circuitry 210 for analysis. According to an embodiment, the I/O interface 250 is configured to analyze the signals captured by the sensors 140, detectors, and the like. According to a further embodiment, the I/O interface 250 is configured to send one or more commands to one or more of the resources 150 for executing one or more plans (e.g., actions) of the digital assistant 120, as further discussed hereinbelow. A plan may include, for example, suggesting that the user play Jazz music via a specific streaming service, suggesting initiation of a navigation plan to a specific address though a selected navigation app, and the like. According to a further embodiment, the components of the controller 200 are connected via a bus 270.

In some configurations, the controller 200 may further include an artificial intelligence (AI) processor 260. The AI processor 260 may be realized as one or more hardware logic components and circuits, including graphics processing units (GPUs), tensor processing units (TPUs), neural processing units, vision processing units (VPU), reconfigurable field-programmable gate arrays (FPGA), and the like. The AI processor 260 is configured to perform, for example, machine learning based on sensory inputs received from the I/O interface 250, where the I/O interface 250 receives input data, such as sensory inputs, from the sensors 140.

In an embodiment, a policy (including the initial policy) may include a set of behavior rules to be used by the I/O device 170 when interacting with a specific user in particular circumstances. The set of behavior rules may include specific guidelines indicating which plan to be executed by the I/O device 170, and in which manner when a specific user is identified in a particular situation. In an embodiment, the policy may be learned and developed through time based on, for example, user behavior, user patterns, user feedback to actions performed by the digital assistant 120, and the like. The initial policy may be preconfigured or learned from user behavior, using reinforcement learning techniques.

The policy, in one configuration, can be defined as pairs of actions and their respective score (expected reward). That is, each action is associated with a score, indicating how likely a user would use or otherwise enjoy the action. The score may be defined between 0 and 1, where 1 is the highest score and 0 is the lowest score. The action may be defined using specific instructions “play music via a music streaming service A” or a general statement. For example, such a statement may include that the first user enjoys listening to Jazz music, that the first user usually selects the longer route on his way back from work, that podcasts about technology are the user's favorite podcasts, and the like. As another example, a policy may define an action suggesting the user to practice yoga upon determination that the user has not moved from the couch for more than two hours, as the user usually likes practicing yoga.

In an embodiment, a request for changing the initial policy (or any current settings of a policy) is received from the external system 180. As noted above, the request may be triggered in response to a promotional event to boost one service over the other, thereby to modify the initial policy. That is, the request for modifying the policy may be received, for example, from a service provider (by the authorized external system 180) that is interested in introducing or promoting a product, service, new feature, and the like. Such a request may include one or more data items. The data items may indicate, for example, a type of a product, a service, and the like to be introduced to the user via the external system 180, description of the product, and so on.

For example, the request may be related to introducing a new music streaming service, such that the data items may include the characteristics of the new service. Such characteristics may include a name of the product, description, advantages, price, link to download the product (e.g., a software), and so on. In an embodiment, the request includes an electronic file that is used for modifying the policy of the I/O device 170.

In an embodiment, the controller 200 is configured to modify (if it is required) the policy based on at least one request and in response to a current state of the user. Modifying the policy may include, for example and without limitation, changing the frequency of suggesting using a certain application (i.e., software) that is used for playing music. The policy may be modified based on the data items of the request received from the external system 180.

For example, the policy that is associated with a user usually causes the I/O device 170 to suggest the first user to listen to music using the following applications: YouTube® and Apple Music®. According to the same example, a request for modifying the policy that is associated with the user may be received from an authorized electronic system that is associated with Spotify®. The request may include data items that, when inputted into the policy, cause modification of the policy that is associated with the user such that the Spotify® application may be used more frequently compared to the other two applications.

Specifically, according to the disclosed embodiments, the controller 200 is configured to generate a modified policy based the current policy and the data included in the request. To this end, the controller 200 is configured to determine what is the type of service and/or product (collectively referred to service) requested to be promoted. Then, the controller 200 is configured to determine if the policy includes a plan already defined for the requested service or similar to the requested service. Going back to the above example, if the requested service to be promoted is Spotify®, it is checked if the initial policy includes a music streaming service for utilizing Spotify® or a different streaming service.

The controller 200 is then configured to increase a score (expected reward) of an action that defines an already existing service (e.g., Spotify®). If the requested service is not defined in the policy, a score associated with a similar service is determined and analyzed. If such score indicates that the user has a strong bias against the current defined service, the requested service will be added to the policy, but with a low score. Alternatively, if such score of the existing service indicates that the user has a weak bias against the current defined service, the requested service (e.g., Spotify®) will be added to the policy, but with a high score. The determination of a strong or weak bias and their determined scores can be performed based on a set of rules and threshold or by an expert system trained by a machine learning model.

In an embodiment, to determine the current state of the user, the controller 200 is configured to collect a dataset about a user of the digital assistant 120. The dataset may be collected from a plurality of sensors (e.g., the sensors 140). The first dataset may include, for example, images, video, audio signals, and the like, that are captured in real-time or near real-time with respect to the user. In an embodiment, the dataset may further include historical data about the user, information regarding user's behavioral patterns, user's routines, user's preferences, and so on. The dataset may include data that is related to the user's environment, such as the temperature outside the user's house or vehicle, traffic conditions, and the like. It should be noted that the dataset may be collected constantly or periodically.

In an embodiment, the controller 200 is configured to analyze the dataset. The analysis may be achieved by applying at least one algorithm, such as a machine learning algorithm, to the dataset. The dataset may be fed into the algorithm (e.g., a machine learning model), thereby allowing the algorithm to determine a current state of the user interacting with the I/O device 170.

The current state may reflect the state of the user and the state of the environment near the user in real-time, or near real-time. The current state may indicate whether, for example, the user is sleeping, reading, stressed, angry, or other actions or emotional behaviors. The current state may further indicate the current time, weather, number of people in the room, people's identity, and so on. As an example, the current state may indicate that the user is sitting in the living room, that three other people are sitting next to the user, the identity of the other three people and that the time is 7:30 pm.

In an embodiment, based on the determined current state, the controller 200 may be configured to determine whether execution of a specific plan defined is desirable, and, in particular, if a plan included in the modified policy should be executed. For example, when the collected dataset indicates that the user is driving and seems to be angry, it may be desirable to executing a plan that plays the user's music from a favorite stream service and not introducing a new service.

That is, the controller 200 is configured to execute a plan using the modified policy based on the determined current state. Execution of a plan may be performed using one or more resources, (the resources 150). For example, the modified policy may determine that when the digital assistant 120 suggests the user to listen to music, a specific application (e.g., Spotify®) will be used for playing music. According to the same example, a plan that suggests the user to listen to music through Spotify® may be executed.

With the system and method described above, the I/O device 170 that operates at the user's natural environment and is used for assisting the user by performing a variety of plans, may be able to promote products, services, features, etc. based on collection of at least real-time data. By identifying an appropriate time for suggesting a new service, product, etc. the impact of the suggestion increases and creates an enhanced way for promoting such products and services.

It should be noted that the modified policy may include multiple behavior rules that relate to many aspects about a user, such as navigation preferences (when the digital assistant 120 is operated in a vehicle), music preferences, patterns, and the like. A modified policy may be generated based on a combination of behavior rules and information included in the request.

In an embodiment, the controller 200 may be configured to execute at least one plan generated by the digital assistant 120 based on the modified policy. A plan is an action or a series of actions that is executed by the digital assistant 120. A plan may be, for example, suggesting that a user listen to a certain type of music, initiating a navigation plan to a specific destination, and the like. It should be noted that the modified policy may affect the way a plan is usually executed, such as, for example and without limitation, by changing the order of a sequence of actions of a certain plan, changing the tone of the voice emitted by the digital assistant 120, and the like.

According to an embodiment, after at least one plan is executed, the controller 200 is configured to collect at least sensor data relating to at least a user response from the user with respect to the execution of the plan which is based on the modified policy. Collecting the sensor data may be achieved using at least one sensor (e.g., the sensors 140). The user response may include verbal expressions, gestures, facial expressions, and the like. The sensor data relating to the user response may be analyzed using, for example, a designated algorithm, such as a machine learning algorithm, where the algorithm is adapted to determine the nature of the user response. In an embodiment, the analysis is performed using, for example and without limitation, one or more computer vision techniques, audio signal processing techniques, machine learning techniques, and the like. Based on the result of the analysis of the user response, the controller 200 may be configured to further update the modified policy based on the preference to the introduced service or product. For example, the policy was modified to include a new streaming service, and the user enjoys such service, the policy is further modified to increase the score of the added streaming service.

With the system and method described above, policies (e.g., behavior policies) of electronic devices may be automatically modified to introduce new services while maintaining the requirements and preferences of the user.

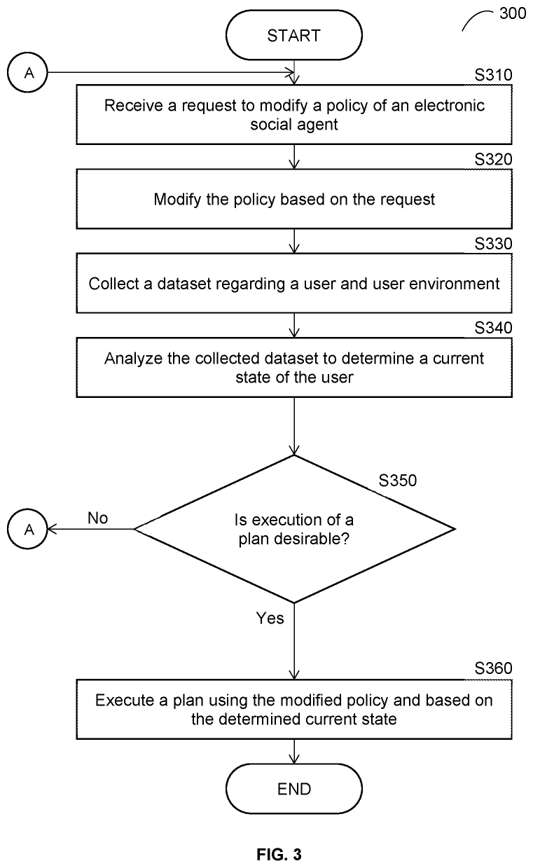

FIG. 3 shows an example flowchart 300 of a method for generating a modified policy for an I/O device in response to promotional events, according to an embodiment. The method described with respect to FIG. 3 may be applicable to a scenario such as, for example and without limitation, a service provider or a vendor wishes to prompt services and/or products to the I/O device to benefit a user of such a device. The modified policy does not negatively affect the experience of the user. The method described herein may be executed by the controller 200 that is further described hereinabove with respect of FIG. 2.

At S310, a request for modifying a policy of an I/O device is received. The modified policy would modify the operation of the digital assistant in the I/O device. The request may be received from an authorized external system (e.g., 180, FIG. 1) in response to, for example, one or more promotional events issued by the policy. The request includes data features that may indicate, for example, a type of a product or a service to be introduced to the user via the digital assistant, a description of the product, a link to update or download a software, or the like. As noted above, the policy is used for controlling interactions between a user of a digital assistant of the I/O device. The policy may be used for determining which plan should be executed, and in what manner, upon determination of a state of the user.

At S320, the policy of the of I/O device as operated by the digital assistant is modified. Modifying the policy may include, changing the frequency with which the policy suggests the use of a service or product designated in the request. In an embodiment, S320 includes modifying a score associated with plan or action related to a requested service. To this end, the initial policy (or current policy) is analyzed to determine if it includes a definition of the requested service and, if so, the score associated with the requested service is compared to related similar services that are also defined in the in the policy (if no such services are defined, their respective score is 0). Further, if the requested service is not defined in the initial (current policy), such service would be treated has having a score of 0.

According to the same embodiment, identification of similar services may be based on various common attributes (e.g., based on a number of common attributes above a threshold, the matching of one or more required common attributes, a combination thereof, and the like). The common attributes may include, as examples and without limitation, type, vendor name, and the like.

The differences between the scores of the requested service and existing service(s) are computed to determine a bias of a user to the requested service. If the score difference is above a bias threshold, the user's bias is strong against the requested service, the respective score of the requested service will be increased by a first value as not to negatively affect the user experience. If the score difference is equal to the bias threshold, the user's bias is neutral against the requested service, and the respective score of the requested service will be increased by a second value to moderately increase the frequency that such service is being utilized. If the score difference is below the bias threshold, the user's bias is weak against the requested service, and the respective score of the requested service will be increased by a third value to significantly increase the frequency that such service is being utilized. The first, second, and third values are predefined, where the first value is lower than the second value, and the second number is a lower than the third value. The bias threshold is also predefined. These values may be defined by a rule-base system, an expert system, or a machine-learning based system. In an example, the score values are numbers between 0 and 1.

As an example, the initial policy includes the following <action, score>:
<play Apple Music®, 0.7>
<play YouTube®, 0.6>
<play Spotify®, 0.4>
   The music streaming service to prompt is Spotify®. The bias threshold is defined to be 0.4. The score difference is at most 0.3, thus the score of the Spotify® service will be increased by the third value (e.g., 0.45). Therefore, the modified policy will be:
<play Apple Music®, 0.7>
<play YouTube®, 0.6>
<play Spotify®, 0.8.5>
   As such, the frequency that now Spotify® would be played is higher than the other two services, thereby allowing promotion of the requested service.

It should be noted that the modification of the policy may be performed for any type of product, service, feature, and the like that can be used by the I/O device and controlled by the digital assistant. The activation of such actions is performed based on the current state of a user.

In an embodiment, S320 includes saving the modified policy in a database, e.g., database 160, FIG. 1.

At S330, a dataset about a user of the I/O device is collected. The first dataset may be collected using one or more sensors, e.g., the sensors 140, from the Internet, from the user's calendar, and the like. Data as may be included in the dataset, which is collected using one or more sensors, such as the sensors 140, may include, without limitation, images, video, audio signals, and the like. Further, such data may be collected in real-time or near-real-time with respect to the first user. In addition, the first dataset may include, without limitation, data related to the environment near the first user such as, for example and without limitation, temperature, traffic conditions, and the like. In an embodiment, the dataset may further include historical data pertaining to the first user, data from one or more web sources, and the like.

At S340, the collected dataset is analyzed to determine the current state of a user. The analysis may be performed by an application of at least one algorithm, such as a machine learning algorithm, which is adapted to determine at least a current state of a user. In an embodiment, the collected dataset is input into a machine learning model that is trained to provide a current state of the user. Such model may be adapted to determine a current state with respect to the environment near the user (e.g., in a predetermined proximity to the user) based on at least a portion of the collected dataset.

The current state may reflect the state of the user and the state of the environment near the user in real-time, or near-real-time. The current state may indicate whether, for example, the user is sleeping, reading, stressed, angry, and so on. The current state may further indicate the current time, the weather, the number of people in the room, the identities of one or more people, or the like.

In other configurations, the collected dataset may be analyzed using, for example and without limitations, one or more computer vision techniques, audio signal processing techniques, unsupervised machine learning techniques, and the like.

At S350, it is determined whether execution of a plan defined in the modified policy is desirable and if so, execution continues with S360; otherwise, execution continues with S310. The determination is based on the current state of the user (determined at S340) and the requested service. For example, if the user's current state is “sleeping”, and the requested service to be promoted is Spotify®, the plan (or action) defined for this service will not be executed. Alternatively, if the current state is “driving”, then the plan related to the request service as defined in the modified service will be executed.

At S360, at least one plan (or action) associated with the requested service is executed based on the modified policy. In an embodiment, executing based on the modified policy, includes causing an input/output (I/O) device to performing the action defined for this service. Referring back to the above example, where the Spotify® streaming service will be executed to play user's favorite music, while the music is played through one of the device's resources (e.g., speakers). It should be noted that the favorite music for the current state may be also defined in the modified policy.

In an embodiment, when the plan is executed, a feedback may be collected from the user though the sensors. The collected feedback may be provided as a dataset to further modify the modified policy. This is, for example, if the user shows positive bias to the introduced new service, the score of the service may be increased.

The various disclosed embodiments are implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of,” followed by a listing of items, means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosure and the concepts contributed by the inventor to furthering the art and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating a modified input/output (I/O) device policy in response to external promotional events, comprising:
generating a modified policy based on a request to promote at least one service, wherein the modified policy is generated based on at least one service currently defined in an initial policy of the I/O device and similar to the at least one service to be promoted;
determining a current state of a user of the I/O device based on a collected dataset related to a user of the I/O device; and
executing, based on the current state, at least one plan defined in the modified policy, wherein executing the at least one plan further includes causing the I/O device to activate at least one service to be promoted.

2. The method of claim 1, wherein generating the modified policy further comprises:
analyzing the initial policy to identify the at least one similar service;
determining a bias of the user against a use of the at least one service requested to be promoted; and
assigning a score to the service requested to be promoted based on the determined bias, wherein the score defines a frequency to activate the service requested to be promoted when executing of the at least one plan.

3. The method of claim 2, wherein the determined bias is any one of: a weak bias, a strong bias, and a neutral bias.

4. The method of claim 3, wherein assigning the score further comprises:
increasing a current score by a first value when the determined bias is strong against the promoted service;
increasing the current score by a second value when the determined bias is neutral against the promoted service; and
increasing the current score by a third value when the determined bias is weak against the promoted service, wherein the first value is lower than the second value and the third value.

5. The method of claim 1, wherein the collected dataset includes real-time data and historical data.

6. The method of claim 5, further comprising:
collecting real-time data related to a user through at least one sensor connected to the I/O device.

7. The method of claim 1, wherein a current state is state of a user and the state of an environment near the user in real-time, or near real-time.

8. The method of claim 1, wherein determining a current state of the user further comprises:
applying a machine learning model trained to determine the current state on the collected dataset.

9. The method of claim 1, wherein the prompted service includes any one of: a service, a product, and a feature that can be operated by a digital assistant included in the I/O device.

10. The method of claim 1, further comprising:
collecting sensor data of a user response by, wherein the sensor data is indicative of the response of the user to the execution of the at least one plan based on the modified policy;
analyzing the collected sensor data; and
updating the modified policy based on the analysis of the collected sensor data.

11. A non-transitory computer readable medium having stored thereon instructions for causing a processing circuitry to execute a process for generating a modified input/output (I/O) device policy in response to external promotional events, the process comprising:
generating a modified policy based on a request to promote at least one service, wherein the modified policy is generated based on at least one service currently defined in an initial policy of the I/O device and similar to the at least one service to be promoted;
determining a current state of a user of the I/O device based on a collected dataset related to a user of the I/O device; and
executing, based on the current state, at least one plan defined in the modified policy, wherein executing the at least one plan further includes causing the I/O device to activate at least one service to be promoted.

12. A system for generating a modified input/output (I/O) device policy in response to external promotional events, comprising:
a processing circuitry; and
a memory, the memory containing instructions that, when executed by the processing circuitry, configure the system to:
generate a modified policy based on a request to promote at least one service, wherein the modified policy is generated based on at least one service currently defined in an initial policy of the I/O device and similar to the at least one service to be promoted;
determine a current state of a user of the I/O device based on a collected dataset related to a user of the I/O device; and
execute, based on the current state, at least one plan defined in the modified policy, wherein executing the at least one plan further includes causing the I/O device to activate at least one service to be promoted.

13. The system of claim 12, wherein the system is further configured to:
analyze the initial policy to identify the at least one similar service;
determine a bias of the user against a use of the at least one service requested to be promoted; and
assign a score to the service requested to be promoted based on the determined bias, wherein the score defines a frequency to activate the service requested to be promoted when executing of the at least one plan.

14. The system of claim 13, wherein the determined bias is any one of: a weak bias, a strong bias, and a neutral bias.

15. The system of claim 14, wherein the system is further configured to:
increase a current score by a first value when the determined bias is strong against the promoted service;
increase the current score by a second value when the determined bias is neutral against the promoted service; and
increase the current score by a third value when the determined bias is weak against the promoted service, wherein the first value is lower than the second value and the third value.

16. The system of claim 12, wherein the collected dataset includes real-time data and historical data.

17. The system of claim 16, wherein the system is further configured to:
collect real-time data related to a user through at least one sensor connected to the I/O device.

18. The system of claim 12, wherein a current state is state of a user and the state of an environment near the user in real-time, or near real-time.

19. The system of claim 12, wherein the system is further configured to:
apply a machine learning model trained to determine the current state on the collected dataset.

20. The system of claim 12, wherein the promoted service includes any one of: a service, a product, and a feature that can be operated by a digital assistant included in the I/O device.

21. The system of claim 12, wherein the system is further configured to:
collect sensor data of a user response by, wherein the sensor data is indicative of the response of the user to the execution of the at least one plan based on the modified policy;
analyze the collected sensor data; and
update the modified policy based on the analysis of the collected sensor data.
